(19) United States
(12) Patent Application Publication
(10) Pub. No.: US 2011/0124773 A1
(43) Pub. Date: May 26, 2011

(54) PROCESS FOR CONTINUOUSLY PRODUCING THERMOPLASTICALLY PROCESSABLE POLYURETHANES

(75) Inventors: Jens HEPPERLE, Koln (DE); Ulrich Liesenfelder, Bergisch Gladbach (DE); Sigurd Buchholz, Koln (DE); Wolfgang Bräuer, Leverkusen (DE); Wolfgang Kaufhold, Koln (DE); Achim Häseler, Leverkusen (DE)

(73) Assignee: BAYER TECHNOLOGY SERVICES GMBH, Leverkusen (DE)

(21) Appl. No.: 12/948,064

(22) Filed: Nov. 17, 2010

(30) Foreign Application Priority Data
Nov. 26, 2009 (DE) 102009055735.0

(51) Int. Cl. C08L 75/04

(52) U.S. Cl. 523/319; 524/875

(57) ABSTRACT

The invention relates to a process for continuously producing thermoplastically processable polyurethanes with improved softening behaviour in a sequence of static mixers.

The invention relates to a process for continuously producing thermoplastically processable polyurethanes with improved softening behaviour in a sequence of static mixers.

Thermoplastic elastomers (TPEs) are of great technical interest because they combine the mechanical properties of vulcanized elastomers (“rubber”) with the processability of thermoplastics. The ability of TPEs to undergo repeated melting and repeated processing is based on the absence of the chemical crosslinking sites present in rubber.

Thermoplastic polyurethane elastomers (TPUs) are a type of TPE and have been known for a long time. TPUs obtain their elastomeric properties via a constitution made of hard and soft blocks. The hard segments form domains which function as physical crosslinking sites. The structure of the TPUs gives, in comparison with crosslinked elastomers, lower heat resistance and less resilience on removal of load, and these can be advantageous in certain applications. A factor which is always advantageous is, in comparison with crosslinked elastomers, lower-cost processing due to shorter cycle times, and recyclability.

A wide variety of mechanical properties can be achieved via use of different chemical structural components. An overview of TPUs, and their properties and applications is found by way of example in the following publications: Kunststoffe 68 (1978), pages 819 to 825 or Kautschuk, Gummi, Kunststoffe 35 (1982), pages 568 to 584.

TPUs are composed of linear polyols, mostly of polyester polyols or of polyether polyols, and of organic diisocyanates and of short-chain diols. The soft segments produced from the reaction between diisocyanate and polyol function as elastic components when mechanical stress is applied. The hard segments (urethane groups) serving as crosslinking sites are obtained via reaction of the diisocyanate with a low-molecular-weight diol for chain-extension purposes. Catalysts can also be used to accelerate the synthesis reaction.

The molar ratios of the structural components can be varied relatively widely in order to adjust physical properties. Molar ratios of polyols to chain extenders (diols) of from 1:1 to 1:12 have proved successful. These give products with Shore hardness in the range from 70 Shore A to 75 Shore D (see the standards DIN 53505 and DIN 7868 for the definition and measurement of Shore hardness).

The thermoplastically processable polyurethane elastomers can be synthesized either stepwise (prepolymer feed process) or via simultaneous reaction of all of the components in one stage (One-Shot feed process). TPUs can be produced continuously or batchwise.

The literature (see, for example, DE2823762A1) discloses production processes in which the starting materials are first mixed in a mixing zone at low temperatures at which no polyaddition occurs, and then react with one another in a reaction zone which has the desired reaction temperature. The mixing zone and reaction zone are preferably provided via static mixers. Homogeneous products are obtained.

There are also known processes in which the mixing of the starting materials takes place after reaction conditions have been established. By way of example, EP1055691B1 describes a continuous process for producing TPU by mixing the starting materials homogeneously in a “One-Shot feed process” into a first static mixer with a shear rate from 500 sec⁻¹ to 50 000 sec⁻¹ within at most 1 second. There can be a second static mixer downstream of the first static mixer. The conversion achieved in the first static mixer is >90%.

DE102005004967A1 proposes, for production of TPU, feeding the starting materials into a self-cleaning twin-screw extruder, which is operated at high shear rates. A disadvantage is, in comparison with the use of static mixers as reactors, reduced mixing action and heat dissipation in twin-screw extruders.

EP1068250B1 describes a process for producing TPU by mixing the starting materials homogeneously within 5 seconds, where the difference between the temperatures of the starting materials prior to introduction within the reactor is less than 20° C. Some examples carry out the reaction in a single static mixer—there is no disclosure of division into different reaction zones.

The publication DE10103424A1 discloses a continuous process for producing TPU in a plate reactor. The plate reactor is composed, in the direction of flow, of an entry module, a mixing module, a residence-time module, a heating module or cooling module, a further residence-time module and a discharge module. The mixing module is responsible for mixing two or more liquids. The residence-time module is responsible for providing sufficient reaction time to the fluids that may be reacting. Neither the description of DE10103424A1 nor the examples listed discloses the magnitude of the residence time or of the conversion in the individual modules. The disclosure of DE10103424A1 does not therefore reveal where the reaction between the starting materials primarily occurs.

The physical properties of TPUs, and in particular their mechanical properties, are very important during their processing and use. By way of example, softening behaviour is important in the case of hot-melt foils, and sinter products, or else when thermal loads are high, for example in the soldering of plastic substrates. Softening behaviour can be characterized via heat-distortion temperatures. These are temperatures at which a test specimen deforms when exposed to an exterior force, as far as a limiting value. Various methods can be used to determine heat distortion, examples being the Vicat method (DIN EN ISO 306) or the method of DIN EN ISO 75.

There is a constant requirement for novel materials which have properties optimized for certain applications. In particular, there is a requirement for TPUs that exhibit improved softening behaviour. An object that therefore arises, starting from the prior art, is to provide TPU with improved softening behaviour. Another object that arises is to provide a process which can produce TPU with improved softening behaviour.

Surprisingly, it has been found that TPUs with lower softening temperature can be produced when the starting materials are first introduced to a first static mixer that provides intensive mixing, where a reaction takes place between some of the starting materials before the materials leave this mixer, and are then introduced into a second static mixer in which the reaction between the starting materials is continued.

The invention therefore provides a process for continuously producing thermoplastically processable polyurethane elastomers with improved softening behaviour, by mixing and reacting the following in a first static mixer with a shear rate from >500 sec⁻¹ to <50 000 sec⁻¹:
one or more polyisocyanates A and
a mixture B which comprises hydrogen atoms that have Zerevitinov activity and which is made of
   B1: from 1 to 85 equivalent %, based on the isocyanate groups in A, of one or more compounds which have, per molecule, at least one 1.8 and at most 2.2 hydrogen atoms that have Zerevitinov activity, and which have an average molar mass M̅ₙ of from 450 to 5000 g/mol, and
   B2: from 15 to 99 equivalent %, based on the isocyanate groups in A, of one or more chain extenders which have, per molecule, at least one 1.8 and at most 2.2 hydrogen atoms that have Zerevitinov activity, and which have a molar mass of from 60 to 400 g/mol,
and also from 0 to 20% by weight, based on the total amount of TPU, of further auxiliaries and additives C,
where the NCO/OH ratio of components A and B used is from 0.9:1 to 1.1:1, and the resultant reaction mixture is then introduced into a second static mixer which has lower shear rate than the first static mixer, where the conversion in the first static mixer is from 10% to 90%, based on starting component A.

For the purposes of the invention, continuous reactions are those in which the inflow of the starting materials into the reactor and the discharge of the products from the reactor take place simultaneously but at separate locations, whereas in the case of batchwise reaction the reaction has a chronological sequence: inflow of the starting materials, chemical reaction and discharge of the products.

Components A and B are heated separately from one another, preferably in a heat exchanger, to a temperature from 170° C. to 250° C., and are fed in liquid form simultaneously and continuously into a first static mixer.

The feed rates of all of the components primarily depend on the desired residence times and, respectively, the conversions to be achieved. As the maximum reaction temperature increases, the residence time should become shorter. The residence time can be controlled, by way of example, via the volume flow rates and the volume of the reaction zone. It is advantageous to use various measurement devices to monitor the progress of the reaction. Devices for measuring temperature, viscosity, thermal conductivity and/or refractive index in fluid streams and/or for measuring (near) infrared spectra are particularly suitable for this purpose.

The components are mixed homogeneously in the first static mixer. It is also possible to use a static-mixer cascade as first static mixer, instead of a single static mixer. A static-mixer cascade is a serial arrangement of two or more static mixers of identical or different type, where their geometry differs by virtue of the type of mixer or by virtue of dimensions, e.g. their diameter, or the width of the mixing bars. It is also possible to arrange a plurality of static mixers or static-mixer cascades in parallel, for example in order to increase the mass flow rate. The mass flow rate increases here by a factor which corresponds to the number of static mixers or static-mixer cascades arranged in parallel. The term a first static mixer is therefore used hereinafter to mean a single static mixer, a single static-mixer cascade, a plurality of individual static mixers arranged in parallel or a plurality of static-mixer cascades arranged in parallel.

The static-mixer cascade can take the form of tubes arranged in parallel, e.g. as in a heat exchanger (described in EP 0087817A1) or can take the form of an apparatus in which the flow channels have parallel arrangement.

Static mixers that can be used according to the invention are described in Chem.-Ing. Techn. 52, No. 4, pages 285 to 291, and also in “Mischen von Kunststoff and Kautschukprodukten” [Mixing of Plastic and Rubber Products], VDI-Verlag, Dusseldorf 1993. It is preferable to use the mixers with crossed bars described in DE2532355A1. By way of example, SMX static mixers from Sulzer may be mentioned. It is particularly preferable to use static mixers which divide the cross section into two channels which narrow to half of the cross section and then widen again to the full cross section, with 90° displacement between the entry and discharge channels. The person skilled in the art terms these mixers “cascade mixers” or “multiflux mixers” (Sluijters De Ingenieur 77 (1965), 15, pp. 33-36).

Other suitable static mixers are those such as SMV or SMXL (Sulzer Koch-Glitsch), Kenics (Chemineer Inc.) or interfacial surface Generator-ISG and low pressure drop mixers (Ross Engineering Inc). Other suitable mixers are those with integrated heat exchanger, e.g. SMR from Sulzer or CSE-XR mixers from Fluitec (disclosed by way of example in: EP 1067352 A1 or Verfahrenstechnik 35 (2001) No. 3, 48-50)

It is advantageous to use an intensive mixer as first static mixer, where this is used to provide very rapid mixing of the starting materials with one another, thus avoiding any possible radial concentration gradient.

By way of example, in the case of a laboratory reactor, the first static mixer is characterized by an interior diameter of the flow channel, transversely with respect to the direction of flow, of from 0.1 mm to 30 mm, preferably from 0.5 mm to 10 mm, particularly preferably from 0.8 mm to 6.0 mm, very particularly preferably from 1.0 mm to 3.0 mm. Other sizes can also be found for industrial-scale static mixers, as a function of scale-up factor.

The mixing in the first static mixer is characterized by a wall shear rate in the range from 100 sec⁻¹ to 50 000 sec⁻¹, preferably from 200 sec⁻¹ to 8000 sec⁻¹, particularly preferably from 500 sec⁻¹ to 6000 sec⁻¹, very particularly preferably from 1000 sec⁻¹ to 4500 sec⁻¹.

The residence time in the first static mixer is in the range from 0.1 sec to 5 sec, particularly preferably from 0.2 sec to 3 sec, very particularly preferably from 0.3 to 2 sec.

The first static mixer is of thermally insulated design or is a mixer preferably heated to from 200° C. to 280° C.

The length/diameter ratio of the first static mixer is from 5:1 to 60:1, preferably from 8:1 to 40:1, particularly preferably from 10:1 to 30:1.

According to the invention, the conversion achieved in the first static mixer, defined as reaction of the NCO groups, is from 10% to 90%, based on starting component A. It is preferable that the conversion in the first static mixer is in the range from 20% to 80%, preferably from 30% to 70%.

The temperature of the reaction mixture on leaving the first static mixer is in the range from 210° C. to 300° C.

According to the invention, the reaction mixture leaving the first static mixer is introduced into a second static mixer. The said second static mixer can also be a static-mixer cascade or a parallel arrangement of static mixers or static-mixer cascades.

The mixing in the second static mixer is characterized by a wall shear rate in the range from 1 sec⁻¹ to 10 000 sec⁻¹, preferably from 10 sec⁻¹ to 5000 sec⁻¹, particularly preferably from 30 sec⁻¹ to 3000 sec⁻¹, very particularly preferably from 50 sec⁻¹ to 1000 sec⁻¹.

The residence time in the second static mixer is in the range from 1 sec to 120 sec, particularly preferably from 2 sec to 60 sec, very particularly preferably from 3 to 25 sec.

In the second static mixer, the reaction between the components is continued. It is preferable that the shear rate in the second static mixer is lower than in the first, i.e. that the amount of mixing action per unit of length in the second static mixer is smaller than in the first static mixer. It is preferable that the residence time in the second static mixer is higher than in the first static mixer.

The second static mixer is an insulated mixer or is a mixer preferably heated to from 200° C. to 260° C. Static mixers that can be used according to the invention are described in Chem.-Ing. Techn. 52, No. 4, pages 285 to 291, and also in “Mischen von Kunststoff and Kautschukprodukten”, VDI-Verlag, Dusseldorf 1993. SMX static mixers from Sulzer may be mentioned by way of example. Other suitable mixers are other static mixers or static mixers with integrated heat exchanger, as set out above for the first static mixer.

The length/diameter ratio of the second static mixer is from 5:1 to 30:1, particularly preferably from 8:1 to 22:1.

The temperature of the reaction mixture on leaving the second static mixer is in the range from 220° C. to 350° C.

The design of the second static mixer can be such as to bring about cooling of the reacting composition. Suitable mixers are those with integrated heat exchanger e.g. SMR from Sulzer or CSE-XR mixers from Fluitec (disclosed by way of example in: EP 1067352 A1 or Verfahrenstechnik 35 (2001) No. 3, 48-50).

The static mixers can have been introduced into a heated or cooled apparatus.

It is possible to add further static mixers in the direction of flow behind the second static mixer. In one preferred embodiment, there is a mixer which follows the second static mixer and which has been designed on the principles familiar to the person skilled in the art in such a way as to ensure cooling of the reacting composition within a few seconds, preferably within 10 sec. The cooling preferably takes place to <300° C., particularly preferably to <280° C. and very particularly preferably to <260° C.

It is also possible to take the mixture leaving the second mixer or a downstream mixer and feed it to a continuously operating kneader and/or extruder (e.g. a ZSK twin-screw kneader from Coperion). Mixing can be used here to incorporate additional liquid or solid auxiliaries into the TPU. The material is preferably pelletized at the end of the extruder.

It is also possible to take the mixture which is leaving the second mixer or downstream mixer, or is introduced into a further mixer, and add, to it, a liquid additive or a molten masterbatch.

In the first and second static mixer, reaction takes place between one or more polyisocyanates A and a mixture B which comprises hydrogen atoms that have Zerevitinov activity and which is made of components B1 and B2, where B1 is one or more compounds which have, per molecule, at least one 1.8 and at most 2.2 hydrogen atoms that have Zerevitinov activity, and which have an average molar mass M̅ₙ of from 450 to 5000 g/mol, and B2 is one or more chain extenders which have, per molecule, at least one 1.8 and at most 2.2 hydrogen atoms that have Zerevitinov activity, and which have a molar mass of from 60 to 400 g/mol.

Examples of organic polyisocyanates A that can be used are aliphatic, cycloaliphatic, araliphatic, heterocyclic and aromatic diisocyanates as described by way of example in Justus Liebigs Annalen der Chemie, 562, pages 75 to 136.

Individual compounds that may be mentioned by way of example are: aliphatic diisocyanates such as hexamethylene diisocyanate, cycloaliphatic diisocyanates, such as isophorone diisocyanate, cyclohexane 1,4-diisocyanate, 1-methylcyclohexane 2,4-diisocyanate and 2,6-diisocyanate, and also the corresponding isomer mixtures, dicyclohexylmethane 4,4′-, 2,4′- and 2,2′-diisocyanate, and also the corresponding isomer mixtures, and aromatic diisocyanates such as tolylene 2,4-diisocyanate, mixtures of tolylene 2,4- and 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates and/or diphenylmethane 2,4′-diisocyanates, 4,4′-diisocyanato-1,2-diphenylethane and naphthylene 1,5-diisocyanate. It is preferable to use diphenylmethane diisocyanate isomer mixtures having more than 96% by weight diphenylmethane 4,4′-diisocyanate content, and in particular diphenylmethane 4,4-diisocyanate and naphthylene 1,5-diisocyanate. The diisocyanates mentioned can be used individually or in the form of mixtures with one another. They can also be used together with up to 15% (based on total diisocyanate) of a polyisocyanate, but at most an amount that produces a thermoplastically processable product. Examples are triphenylmethane 4,4′,4″-triisocyanate and polyphenyl polymethylene polyisocyanates.

Component B1 used comprises linear hydroxy-terminated polyols which have, per molecule, an average of from 1.8 to 3.0, preferably up to 2.2, hydrogen atoms that have Zerevitinov activity, and which have a molar mass of from 450 to 5000 g/mol. The production process often causes these to comprise small amounts of nonlinear compounds. Another expression often used is therefore “polyols that are in essence linear”. Preference is given to polyester diols, polyether diols, polycarbonate diols, or a mixture of these.

Suitable polyether diols can be produced by reacting one or more alkylene oxides having from 2 to 4 carbon atoms in the alkylene moiety with a starter molecule which comprises two active hydrogen atoms. Examples that may be mentioned of alkylene oxides are: ethylene oxide, propylene 1,2-oxide, epichlorohydrin and butylene 1,2-oxide and butylene 2,3-oxide. It is preferable to use ethylene oxide, propylene oxide and mixtures of propylene 1,2-oxide and ethylene oxide. The alkylene oxides can be used individually, in alternation with one another or in the form of a mixture. Examples of starter molecules that can be used are: water, amino alcohols, such as N-alkyldiethanolamines, e.g. N-methyl-diethanolamine and diols, such as ethylene glycol, propylene 1,3-glycol, 1,4-butanediol and 1,6-hexanediol. It is also possible, if appropriate, to use a mixture of starter molecules. Other suitable polyetherols are the tetrahydrofuran-polymerization products comprising hydroxy groups. It is also possible to use proportions of from 0 to 30% by weight, based on the bifunctional polyethers, of trifunctional polyethers, but at most an amount that produces a thermoplastically processable product. The polyether diols that are in essence linear preferably have molar masses of from 450 to 5000 g/mol. They can be used either individually or else in the form of a mixture with one another.

Suitable polyester diols can by way of example be produced from dicarboxylic acids having from 2 to 12 carbon atoms, preferably from 4 to 6 carbon atoms, and from polyfunctional alcohols. Examples of dicarboxylic acids that can be used are: aliphatic dicarboxylic acids, such as succinic acid, glutaric acid, adipic acid, suberic acid, azelaic acid and sebacic acid, and aromatic dicarboxylic acids, such as phthalic acid, isophthalic acid and terephthalic acid. The dicarboxylic acids can be used individually or in the form of a mixture, e.g. in the form of a succinic, glutaric and adipic acid mixture.

For production of the polyester diols it can, if appropriate, be advantageous to use, instead of the dicarboxylic acids, the corresponding dicarboxylic acid derivatives, such as carboxylic diesters having from 1 to 4 carbon atoms in the alcohol moiety, carboxylic anhydrides or acyl chlorides. Examples of polyfunctional alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol and dipropylene glycol. As a function of the properties desired, the polyfunctional alcohols can be used alone or, if appropriate, in a mixture with one another. Other suitable compounds are esters of carboxylic acid with the diols mentioned, in particular those having from 4 to 6 carbon atoms, e.g. 1,4-butanediol and/or 1,6-hexanediol, condensates of ω-hydroxycarboxylic acids, such as co-hydroxycapronoic acid, and preferably polymerization products of lactones, examples being optionally substituted co-caprolactones. Polyester diols preferably used are ethanediol polyadipates, 1,4-butanediol polyadipates, ethanediol 1,4-butanediol polyadipates, 1,6-hexanediol neopentyl glycol polyadipates, 1,6-hexanediol 1,4-butanediol polyadipates and polycaprolactones. The molar masses of the polyester diols are from 450 to 5000 g/mol and they can be used individually or in the form of a mixture with one another.

Component B2 used comprises diols or diamines which have, per molecule, an average of 1.8 to 3.0, preferably 2.2 hydrogen atoms that have Zerevitinov activity, and which have a molar mass of from 60 to 400 g/mol, preferably aliphatic diols having from 2 to 14 carbon atoms, e.g. ethanediol, 1,6-hexanediol, diethylene glycol, dipropylene glycol and in particular 1,4-butanediol. However, other suitable compounds are diesters of terephthalic acid with glycols having from 2 to 4 carbon atoms, e.g. bis(ethylene glycol) terephthalate or bis(1,4-butanediol) terephthalate, hydroxyalkylene ethers of hydroquinone, e.g. 1,4-di(β-hydroxyethyl)hydroquinone, ethoxylated bisphenols, e.g. 1,4-di(β-hydroxyethyl)bisphenol A, (cyclo)aliphatic diamines, e.g. isophoronediamine, ethylenediamine, 1,2-propylenediamine, 1,3-propylenediamine, N-methylpropylene-1,3-diamine, and N,N′-dimethylethylenediamine, and aromatic diamines, e.g. 2,4-tolylenediamine and 2,6-tolylenediamine, 3,5-diethyl-2,4-tolylenediamine and/or 3,5-diethyl-2,6-tolylenediamine, and primary mono-, di-, tri- and/or tetraalkyl-substituted 4,4′-diaminodiphenylmethanes. It is also possible to use a mixture of the abovementioned chain extenders. It is also possible to add relatively small amounts of triols.

It is also possible to use small amounts of conventional monofunctional compounds, e.g. as chain terminators or mould-release aids. Examples that may be mentioned are alcohols, such as octanol and stearyl alcohol, or amines, such as butylamine and stearylamine.

To produce the TPUs, the amounts reacted of the structural components, if appropriate in the presence of catalysts, of auxiliaries and/or of additives, can preferably be such that the equivalence ratio of NCO groups A to the entirety of the NCO-reactive groups, in particular of the OH groups, of the low-molecular-weight diols/triols B2 and polyols B1, is from 0.9:1.0 to 1.1:1.0, preferably from 0.95:1.0 to 1.10:1.0.

Suitable catalysts according to the invention are the tertiary amines that are conventional and known in the prior art, examples being triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organometallic compounds, such as titanic esters, iron compounds, tin compounds, e.g. tin diacetate, tin dioctoate, tin dilaurate or the dialkyltin salts of aliphatic carboxylic acids, e.g. dibutyltin diacetate, dibutyltin dilaurate or the like. Preferred catalysts are organometallic compounds, in particular titanic esters, iron compounds and/or tin compounds.

Alongside the TPU components and the catalysts, it is also possible to add auxiliaries and/or additives C in amounts of up to 20% by weight, based on the total amount of TPU. They can be predissolved in one of the TPU components, preferably in component B1, or else, if appropriate, can be added in a downstream mixing assembly, e.g. an extruder, after the reaction has taken place. Examples that may be mentioned are lubricants, such as fatty acid esters, metal soaps of these, fatty acid amides, fatty acid ester amides and silicone compounds, antiblocking agents, inhibitors, stabilizers to counter hydrolysis, light, heat and discoloration, flame retardants, dyes, pigments, inorganic and/or organic fillers and reinforcing agents. Reinforcing agents are in particular fibrous reinforcing agents, e.g. inorganic fibres, which are prepared in accordance with the prior art and can also have been treated with a size. Further details concerning the auxiliaries and additives mentioned can be found in the technical literature, for example in the monograph by J. H. Saunders and K. C. Frisch “High Polymers”, Volume XVI, Polyurethane, Parts 1 and 2, Verlag Interscience Publishers 1962 or 1964, or in Taschenbuch für Kunststoff-Additive [Plastics Additives Handbook] by R. Gächter and H. Müller (Hanser Verlag, Munich 1990), or in DE-A 29 01 774.

Other additives that can be incorporated into the TPU are thermoplastics, such as polycarbonates and acrylonitrile/butadiene/styrene terpolymers, in particular ABS. It is also possible to use other elastomers, such as rubber, ethylene/vinyl acetate copolymers, styrene/butadiene copolymers, and also other TPUs. Other materials suitable for incorporation are commercially available plasticizers, such as phosphates, phthalates, adipates, sebacates and esters of alkylsulphonic acids.

The present invention also provides TPUs produced by the process according to the invention. Surprisingly, it has been found that by virtue of the division of the reaction into two reaction zones with different mixing action and with different average residence time, according to the invention, the resultant TPUs have improved softening behaviour. It appears that these conditions achieve lower block lengths for the hard segments than in the processes known from the prior art, with resultant lowering of softening point.

The TPU produced by the process according to the invention can be processed to give injection mouldings, and extruded items, and in particular to give foils, to give coating compositions or to give sinter grades and to give readily fusible coextrusion grades, e.g. lamination grades, calandaring grades and powder/slush grades. A particular feature of the material, associated with good homogeneity, is that it, and the mouldings produced therefrom, has a low softening point.

The examples below will be used for further explanation of the invention, but the invention is not restricted thereto.

The shear rate of the cascade mixers used in the examples is calculated in the form of representative shear rate by way of the following formula for rectangular channels (described in M. Pahl, W. Gleiβle and H. M. Laun, Praktische Rheologie der Kunststoffe and Elastomere [Practical Rheology of Plastics and Elastomers], VDI Verlag, 1996):

$${γ}^{\&} = \frac{6 \cdot {V}^{\&}}{B \cdot {H}^{2}}$$

where γ& is the representative wall shear rate, V& designates the volume flow rate, B designates the channel width and H designates the channel height.

For SMX static mixers, the shear rate is calculated in the form of representative shear rate by way of the following relationship known to the person skilled in the art:

$${γ}^{\&} = 8 \frac{4 \cdot {V}^{\&}}{π \cdot {R}^{3}}$$

where γ& is the representative wall shear rate, V& designates the volume flow rate, and R is the internal tube diameter and π is the ratio of a circle's circumference to its radius (π≈3,14159265).

### EXAMPLE 1

### Inventive Example 94B (Based on PE 90 B))

The reactor is composed of a plurality of static mixers arranged in series. The first static mixer for the purposes of the present invention is composed of two cascade mixers arranged in series with an entry channel diameter of B=1.5 mm and with a channel height of H=1.5 mm. The second static mixer for the purposes of the present invention is composed of four SMX mixers arranged in series each with L/D=5 and with a downstream Kenics mixer with L/D=28 (see Table 1).

The following were added separately from one another: 3404 g/h of a mixture of polyol (PE 90 B=polybutylene adipate, average molar mass Mn=950 g/mol) which comprised 23 ppm, based on Ti metal concentration, of an organic titanate catalyst (Tyzor solution, DuPont), and 1,4-butanediol, in a polyol:butanediol ratio by weight of 7.42:1, and also 1904 g/h of 4,4-MDI. The temperature of the MDI and of the polyol/butanediol mixture was respectively 200+/−10° C. The components were mixed in an all-round-heated arrangement of the plurality of mixers listed in Table 1. D here means diameter, H here means channel height, B here means channel width, Ltot means total length, Vtot means total volume, γ means shear rate and t_rt means the residence time in the mixer.

TABLE 1
Arrangement of mixer cascade
Example 1:

| | | | D | H | B | Ltot | Ltot/D | Vtot | γ | t_rt |
|---|---|---|---|---|---|---|---|---|---|---|
| No. | Number | Apparatus | [mm] | [mm] | [mm] | [mm] | [mm] | [cm³] | [1/s] | [s] |
| 1 | 2 | Cascade mixer, normal, 2x | | 1.5 | 1.5 | 54 | 36.0 | 0.48 | 2620 | 0.32 |
| 2 | 4 | SMX mixer, 6 mm, L/D = 5 | 6 | | | 120 | 20.0 | 2.88 | 556 | 1.96 |
| 3 | 1 | Kenics 6 mm × 165 mm | 5.8 | | | 165 | 28.4 | 3.69 | | 2.50 |

This process could produce TPU for a period of more than 120 min without any pressure rise observed prior to the static-mixer cascade.

### EXAMPLE 2

### Inventive Example Based on 135 Polyether

The reactor is composed of a plurality of static mixers arranged in series. The first static mixer for the purposes of the present invention is composed of two cascade mixers arranged in series with an entry channel diameter of B=1.5 mm and with a channel height of H=1.5 mm. The second static mixer for the purposes of the present invention is composed of four SMX mixers arranged in series each with L/D=5 and with a downstream Kenics mixer with L/D=28 (see Table 1).

The following were added separately from one another: 3300 g/h of a mixture of polyol (Terathane 1000-Fa INVISTA) average molar mass Mn=1000 g/mol) which comprised 250 ppm of tin dioctoate (Desmorapid SO, Bayer), and 1,4-butanediol, in a polyol:butanediol ratio by weight of 8.23:1, and also 1719 g/h of 4,4-MDI. The temperature of the MDI and of the polyol/butanediol mixture was respectively 200+/−10° C. The components were mixed in an all-round-heated arrangement of the plurality of mixers listed in Table 1.

D here means diameter, H here means channel height, B here means channel width, Ltot means total length, Vtot means total volume, γ means shear rate and t_rt means the residence time in the mixer.

TABLE 2
Arrangement of mixer cascade

| | | | D | H | B | Ltot | Ltot/D | Vtot | γ | t_rt |
|---|---|---|---|---|---|---|---|---|---|---|
| No. | Number | Apparatus | [mm] | [mm] | [mm] | [mm] | [mm] | [cm³] | [1/s] | [s] |
| 1 | 2 | Cascade mixer, normal, 2x | | 1.5 | 1.5 | 5 | 36.0 | 0.48 | 2480 | 0.34 |
| 2 | 4 | SMX mixer, 6 mm, L/D = 5 | 6 | | | 120 | 20.0 | 2.88 | 526 | 2.07 |
| 3 | 1 | Kenics 6 mm × 165 mm | 5.8 | | | 165 | 28.4 | 3.69 | | 2.65 |

This process could produce TPU for a period of more than 120 min without any pressure rise observed prior to the static-mixer cascade.

### EXAMPLE 3

### Comparison by Analogy with EP 1055691

The above polyester butanediol mixture of Example 1 was added continuously to a SMX static mixer from Sulzer.

| | | | |
|---|---|---|---|
| 2x | DN 20 | Length 195 mm | Diameter 19 mm |
| 1x | DN 70 | Length 700 mm | Diameter 70 mm |

Shear rate: 1400 and 70 sec⁻¹

### Time: 1.0 and 10 sec

Diphenylmethane 4,4′-diisocyanate was simultaneously pumped continuously, as in Example 1, into the static mixer.

The resultant TPU was directly added to the first feed point (barrel section 1) of an extruder (ZSK 83 from Werner/Pfleiderer). The ethylene bisstearylamide was added to the same barrel section. The hot melt was drawn off as strand at the end of the extruder, cooled in a water bath and pelletized.

### EXAMPLE 4

### Production of Injection Mouldings from the TPUS of Examples 1 to 3

The respective TPU pellets from Examples 1 to 3 were melted in a D 60 injection-moulding machine from Mannesmann (32-series screw) (melt temperature about 225° C.) and moulded to give plaques (125 mm×50 mm×2 mm).

### EXAMPLE 5

### Temperature-Related Dynamic-Mechanical Analysis (DMA)

Taking each of the injection-moulded specimens from Example 4, a test specimen (50 mm×12 mm×2 mm) stamped out from the injection-moulded plaque was used for a temperature-related dynamic-mechanical measurement in the torsion pendulum test by analogy with DIN 53 445.

The measurements were made using a DMS6100 from Seiko at 1 Hz in the temperature range from −125° C. to 250° C. with a heating rate of 2° C./min. The softening behaviour according to the invention is characterized by stating, in Table 3 below, the glass transition temperature TG, the modulus at 20° C. and the temperature at which the storage modulus E′ reaches the value 2 MPa (the softening point).

TABLE 3
Properties of test specimen

| Specimen from | | | | |
|---|---|---|---|---|
| injection-moulded | | | | |
| specimen of | | | | |
| material from | Polyol | | DMA E′ | DMA T |
| example | basis | DMA TG | (20° C.) | (2 MPa) |
| 1 | PE 90 B | −17° C. | 61 | 119° C. |
| 2 | Ter. 1000 | −41° C. | 40 | 144° C. |
| 3 (Comparison) | PE 90 B | −19° C. | 72 | 133° C. |

Comparison of the injection-moulded specimens of Example 3 with Example 1 shows that, for identical chemical formulation, the process according to the invention markedly lowers the softening range.

The DMA results for Example 2 show that the process according to the invention can also be carried out with a polyether-based formulation.

1. Process for continuously producing thermoplastically processable polyurethane elastomers, by mixing and reacting the following in a first static mixer with a shear rate from >500 sec⁻¹ to <50 000 sec⁻¹:
one or more polyisocyanates A and
a mixture B which comprises hydrogen atoms that have Zerevitinov activity and which is made of
B1: from 1 to 85 equivalent %, based on the isocyanate groups in A, of one or more compounds which have, per molecule, at least one 1.8 and at most 2.2 hydrogen atoms that have Zerevitinov activity, and which have an average molar mass M̅ₙ of from 450 to 5000 g/mol, and
B2: from 15 to 99 equivalent %, based on the isocyanate groups in A, of one or more chain extenders which have, per molecule, at least one 1.8 and at most 2.2 hydrogen atoms that have Zerevitinov activity, and which have a molar mass of from 60 to 400 g/mol,
and also from 0 to 20% by weight, based on the total amount of TPU, of further auxiliaries and additives C,
where the NCO/OH ratio of components A and B used is from 0.9:1 to 1.1:1, and the resultant reaction mixture is then introduced into a second static mixer which has lower shear rate than the first static mixer, where the conversion in the first static mixer is from 10% to 90%, based on starting component A.

2. Process according to claim 1, wherein the flow channels of the first static mixer have, transversely with respect to the direction of flow, an interior diameter in the range from 0.1 to 30 mm.

3. Process according to claim 1, wherein the wall shear rate in the first static mixer is in the range from 100 sec⁻¹ to 50 000 sec⁻¹.

4. Process according to claim 1, wherein the residence time in the first static mixer is in the range from 0.1 sec to 5 sec.

5. Process according to claim 1, wherein the length/diameter ratio of the first static mixer is from 5:1 to 60:1.

6. Process according to claim 1, wherein the conversion achieved in the first static mixer is from 20% to 80%, based on starting component A.

7. Process according to claim 1, wherein the wall shear rate in the second static mixer is in the range from 1 sec⁻¹ to 10 000 sec⁻¹.

8. Process according to claim 1, wherein the residence time in the second static mixer is in the range from 1 sec to 120 sec.

9. Process according to claim 1, wherein the length/diameter ratio of the second static mixer is from 5:1 to 30:1.

10. Process according to claim 1, wherein, during the mixing of the components in the first and/or second static mixers, heat is introduced or dissipated.

11. Process according to claim 1, wherein the second static mixer is followed by a mixer which ensures cooling of the reactant composition within 10 sec, where the cooling takes place to <300° C.

12. Process according to claim 1, wherein the temperature of the reacting components at the entry to the static mixer is >180° C.

13. Process according to claim 1, wherein component A comprises diphenylmethane diisocyanate isomer mixtures having more than 96% by weight diphenylmethane 4,4′-diisocyanate content.

14. Process according to claim 1, wherein component B1 comprises polyester diols, polyether diols, polycarbonate diols, or a mixture thereof.

15. Thermoplastically processable polyurethane elastomers produced by the process of claim 1.

16. Process of claim 13, wherein said component A comprises diphenylmethane 4,4′-diisocyanate and naphthylene 1,5-diisocyanate.
